(19) United States
(12) Patent Application Publication
(10) Pub. No.: US 2019/0028849 A1
(43) Pub. Date: Jan. 24, 2019

(54) MOBILE DEVICE DETECTION AND TRACKING

(71) Applicant: BlueFox, Inc., Saratoga, CA (US)

(72) Inventors: Thomas Sandholm, Saratoga, CA (US); Hang Ung, Saratoga, CA (US); Philippe René Morin, Goleta, CA (US)

(21) Appl. No.: 15/989,134

(22) Filed: May 24, 2018

Related U.S. Application Data
(60) Provisional application No. 62/535,830, filed on Jul. 22, 2017.
(60) Provisional application No. 62/539,868, filed on Aug. 1, 2017.

(51) Int. Cl. H04W 4/029; G06F 17/30

(52) U.S. Cl. CPC H04W 4/029; G06F 17/30424; G06F 17/3033; G06F 17/30324

(57) ABSTRACT

Disclosed herein is a technique to improve the processing of people counting systems. The technique involves the use of a system that counts the local number of wireless/mobile devices via machine identifiers. When the counting device scrapes the machine identifier from a mobile device, the identifier is hashed using a one-way hash function. The hash code corresponds to a bit location on a bitmap. The location in the bitmap is checked. If the bit is already marked full, the mobile device has been previously detected, if the pixel location is empty, this is a new device. Thus, a single bit represents each machine identifier. The number of unique people in a monitored location is the number of full bits in the bitmap.

### CLAIM FOR PRIORITY

The presently filed application claims priority to U.S. Provisional Patent Application No. 62/535,830, entitled “Mobile Device Detection and Tracking,” and filed Jul. 22, 2017 and U.S. Provisional Application No. 62/539,868 entitled “Mobile Device Detection and Tracking,” and filed Aug. 1, 2017, both of which are incorporated by reference herein in their entirety.

### TECHNICAL FIELD

Teachings relate to electronic data management and more specifically, but not exclusively, to efficient use of memory to track a number of people via their respective mobile devices.

### BACKGROUND

People tracking via mobile devices often involves a system that scrapes MAC addresses or other types of machine identifiers from the mobile devices. Machine identifiers are often long strings of characters. Over the course of hundreds, or thousands, of collected machine identifiers, a system searching that collected list for matches, or specific addresses can become noticeably cumbersome.

### BRIEF DESCRIPTION OF THE DRAWINGS

FIG. 1 is an exemplary top-level block diagram illustrating an embodiment of a mobile detection system.

FIG. 3 is a flowchart illustrating a method of logging a mobile device.

FIG. 3 is an illustration of a bitmap for storing mobile device identifiers.

FIG. 4 is a flowchart illustrating a method of rolling bitmaps for consistent coverage.

FIG. 5 is a block diagram illustrating data management between a detector and an application server.

FIG. 6 is a flowchart illustrating a method of maintaining multiple bitmap tracking systems over variable time periods.

FIG. 7 is a block schematic diagram of a system in the exemplary form of a computer system within which a set of instructions for causing the system to perform any one of the foregoing methodologies and logical flows may be executed.

### DETAILED DESCRIPTION

Disclosed herein is a technique to improve the processing of people counting devices. In order to achieve these goals, the technique involves the use of a device that counts the local number of wireless/mobile devices. When the counting device scrapes a machine identifier from a mobile device, the identifier is hashed using a one-way hash function. The hash code corresponds to a bit location on a bitmap. The location in the bitmap is checked. If the bit is already marked full, the mobile device has been previously detected, if the bit location is empty, this is a new device. Thus, a single bit represents each machine identifier.

The bitmap system is computationally light and enables the person counting device to operate more efficiently.

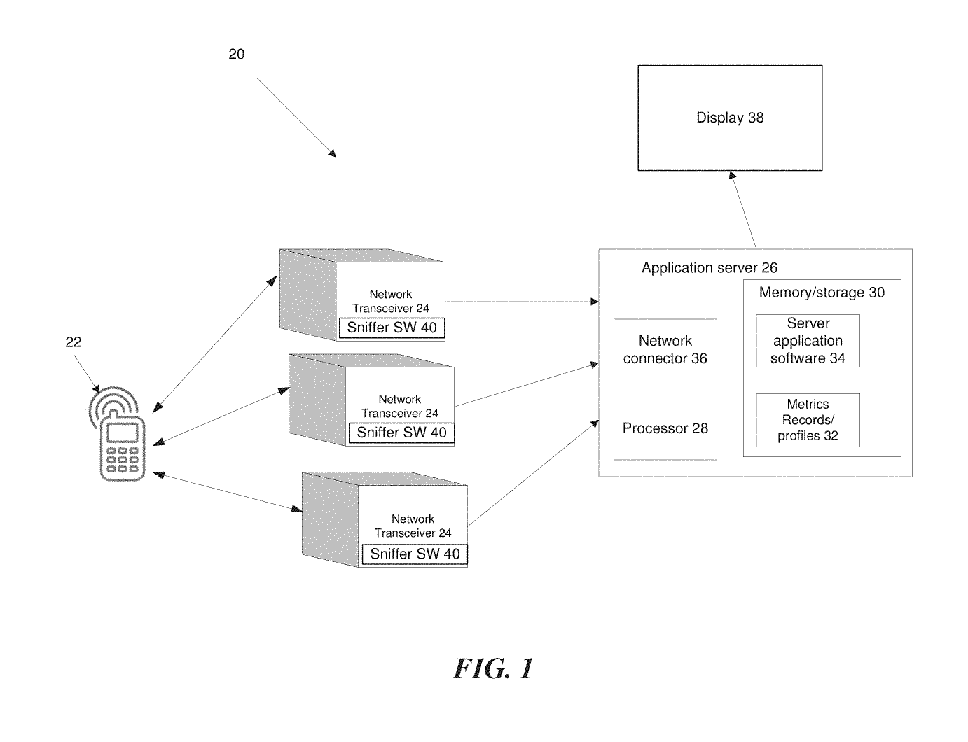

FIG. 1 is an exemplary top-level block diagram illustrating an embodiment of mobile detection system 20. The system 20 relates to mobile devices 22 carried on a user's person. The mobile devices 22 are detected by network transceivers 24. Network transceivers 24 are detection devices or mobile stations (MS), which colloquially can be referred to as fake hotspots or sniffers, that collect identification data from mobile devices 22. Data collected by the network transceivers 24 is forwarded to an application server 26 via the Internet. The application server 26 includes a processor 28 and a data storage or memory 30 for logging metrics 32 and running application analytical software 34. The results of the analysis of metrics 32 are displayed or rendered to a user on a display 38.

Mobile devices such as cellular phones, tablets, or other portable networked devices emit signals in Bluetooth, WiFi, and cellular (i.e. 2G, 3G, 4G, Edge, H+, etc.). These signals attempt to connect to paired devices, hotspots, cell towers, or other suitable wireless connection points to greater networks (“hotspots”). In order to connect to hotspots, mobile devices send out identifying data to establish a connection.

If the mobile device is tricked into attempting to connect with a network transceiver disguised as a hotspot, the fake hotspot may unobtrusively collect the identification data of the mobile device (such as a machine identifier) and then reject the connection request. The fake hotspot collects data in real-time on the mobile device, and by association, collects data regarding the human carrying the mobile device. This data collection occurs without alerting or impeding the human carrier. The system uses analytical software to determine, for example, an approaching unique ID user's presence, history, frequency of visits, duration of presence, and so on. The type of data available to the fake hotspots varies based on a number of details, such as the kind of hotspot used.

In some embodiments, the network transceiver 24 is a “sniffer device” rather than a “fake hotspot.” A sniffer uses the beacon pulses/RTS packets/CTS packets/data link layer packets emitted by a device to identify the emitting device from others.

In some embodiments, a dashboard selects and controls data that is received from the network transceivers 24 at the application server 26. The dashboard can control, from a distance, data captured by the network transceivers 24 as well as new visitor characteristics, history of data used, the number of mobile devices that can be sensed, demographics regarding a selected user, and so on.

The network transceivers 24 may include a plurality of sensors and communicative devices. Examples include wireless fidelity (WiFi) sensors, cell signal 2G, and Femto sensors for 3G and 4G for sensing a user's mobile device 22.

Mobile devices 22 emit WiFi signals automatically. WiFi signals carry identifying data including the MAC address (unique ID number), power of the signal, distance of mobile device 22 from the network transceiver 24, brand of the mobile device 22, name of the mobile device 22 (given by the user), and the network name the mobile device 22 used to connect.

Cell signals (2G, 3G, 4G, etc.) emitted by a phone also occur automatically. The network transceivers 24 detect this signal with an active action on a regular basis to collect the MAC address (unique ID number), SIM card number (IMSI), power of the signal, distance of mobile device 22 from network transceiver 24, carrier, nationality of the mobile device 22, list of applications which attempt to update, and the addresses of the web pages already open (or cached) on the mobile device 22.

Cell signal in this case refers to both CDMA and GSM type networks. While normally CDMA networks would not necessarily use mobile devices 22 with SIM cards, SIM cards exist in devices that use 4G LTE signals. Additionally, in the U.S., CDMA carriers use network-based whitelists to verify their subscribers. The mobile device 22 will still have a unique ID for the carrier to use for identification.

The network transceivers may additionally include processors 28 for internal operations and/or for accepting some of the analytical processing load from the application server 26. Network transceivers 24 may also employ sniffer software 40. Sniffer software 40 includes program operations of the network transceivers 24 as well as network protocol software. Examples of network protocol software include adaptations of OpenBTS (Open Base Transceiver System) and OpenBSC (Open Base Station Controller), with additional features as taught herein. OpenBTS is stable, more complete for GSM, and has a release for UMTS (Universal Mobile Telecommunications System). OpenBTS includes the functionality to perform complete man-in-the-middle attacks. It is worth noting that OpenBSC makes use of OpenBTS for its BTS functionalities.

Using OpenBTS software, examples of base model hardware that may be used for the network transceiver are adaptations of communications platforms manufactured by Ettus Research, Fairwaves, and Nuand.

For cellular signals, there are two distinguishable cases: idle mode and non-idle mode. In idle mode, the mobile device 22 performs the selection and re-selection of a base station to make sure that the mobile device 22 is attached with the best possible channel to the carrier network. In non-idle mode, a mobile device 22, with a point-to-point active call, will perform a base station handover to assure that the call is not dropped.

In order for the mobile device 22 to choose to identify itself to the network transceivers 24, the mobile device 22 has to reselect the cell managed by the network transceivers 24 and push them to identify/authenticate. A set of criteria is defined in the standard mobile phone regarding this selection/re-selection procedure. A BCCH frequency scan can be described as follows: the mobile device 22 scans a set of frequencies to detect a BCCH frequency to camp on. Criteria for cell eligibility can be selected or re-selected. These cells include timing information. In some embodiments, every five seconds, the network transceiver 24 calculates the parameters for the serving cell and for non-serving cells.

GSM, UTRAN, and/or LTE (2G, 3G, 4G) cell reselection is feasible. Therefore, within the sniffer software 40 are programmed, unique approaches for each. According to the network requests, a network transceiver 24 provides specific identification parameters to a fake network (e.g., IMSI or IMEI). The network initiates the identification procedure by transferring an IDENTITY REQUEST message to the network transceiver 24 and starts a timer T3270. The IDENTITY REQUEST message specifies the requested identification parameters in the identity type information element. The IMSI and/or IMEI may be requested.

In some embodiments, the data network includes a wired data network and/or any category of conventional wireless communication networks; for example, radio, Wireless Fidelity (WiFi), cellular, satellite, and broadcasting networks. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT), and others.

The sensors can acquire data on the media access control (MAC address), signal strength, timestamp of probes received, and so on, from the mobile device. In some embodiments, the sensors can be integrated into the display device and/or placed as a separate unit collecting data metrics per location and uploading them to the central server. Additional sensors improve the accuracy of the wireless metrics as well as cover multiple areas within a location. Other sensors that can be used include Bluetooth, GSM/2G, and so on.

FIG. 2 is a flowchart illustrating a method of logging a mobile device. Ultimately, the goal is to store the data of a MAC address (˜6-8 bytes), or some other machine identification, with significantly less data, such as a single bit of data. In step 202, a mobile device detection system detects a first mobile device. In step 204, the detection system obtains the first mobile devices machine identifier. The machine identifier may be a MAC address, a SIM card identifier, or another suitable form of device identification known in the art.

In step 206, the machine identifier is processed through a one-way hash function. The hash function is consistent such that for the same input, the hash function will always produce the same output. Further, the hash function produces output across a wide range. As with any hash function, the goal is to reduce the total number of possibilities of input to a smaller list of possible outputs. The input, a MAC address for example, has a high degree of complexity (˜6-8 bytes). The output is less than that. The hash function thus accepts a degree of possible error (duplicates) in favor of speed/less memory usage.

In some embodiments the hash function treats different portions of a MAC address differently. For example, for MAC addresses with multiple parts, a vendor MAC and a device-specific MAC, the hash function may process the MAC in separate parts. In some cases, for popular mobile devices, the vendor MAC may be identical for many devices. Thus, in these embodiments, some vendor MACs are assigned a greater share of the range of output of the hash function. It's expected that the detection system will encounter many devices from the given vendor as opposed to another vendor. The less popular vendors are less likely to have collisions in data, so these vendors are given a smaller share of the potential output of the hash function.

In some embodiments, the hash function resolves the issue of having a popular vendor by generating highly varied output despite having similar input. This can be achieved by rearranging the characters of the MAC address (both portions vendor and device portions together), or using select characters from both the vendor MAC and the device MAC portions to create more varied combinations. Thus, even though the vendor MACs across many devices are very similar (or the same), the respective MACs would still have very different hashes.

In step 208, the hash of the mobile device machine identifier is scaled to the bitmap used. The bitmap(s) used by a given detection system are sized based on the length of time a given bitmap is expected to operate and what expected traffic by the detection system is. A system expecting 100 people during a given period would have use a notably smaller bitmap than a detection system expecting 50,000 people in the same period. In some embodiments, expecting 100 devices can be supported by a bitmap including two to the 10-12th power of bits (˜1 k-4 k of data). Thus, the scaling function scales the output of the hash function to a corresponding location in the used bitmap depending on the size of the bitmap.

In step 210, the detection system checks the bitmap at the bit indicated by the scaled hash output. In step 212, the detection system determines whether that bit is full (0 or 1). If the bit is empty, in step 214, the detection system fills the bit, and the device is considered detected. If the bit is full, in step 216, the detection system has seen that device before (since the previous clear of the bitmap) and this device has already been counted.

In step 218, the detection system queries the count of devices. The query checks the relevant bitmap(s) and counts the number of full bits. The number of full bits is the number of devices in range of the detection system. Some device may fill the same bit, and thus there is a potential degree of error; however, this error is acceptable when generating estimates people counting.

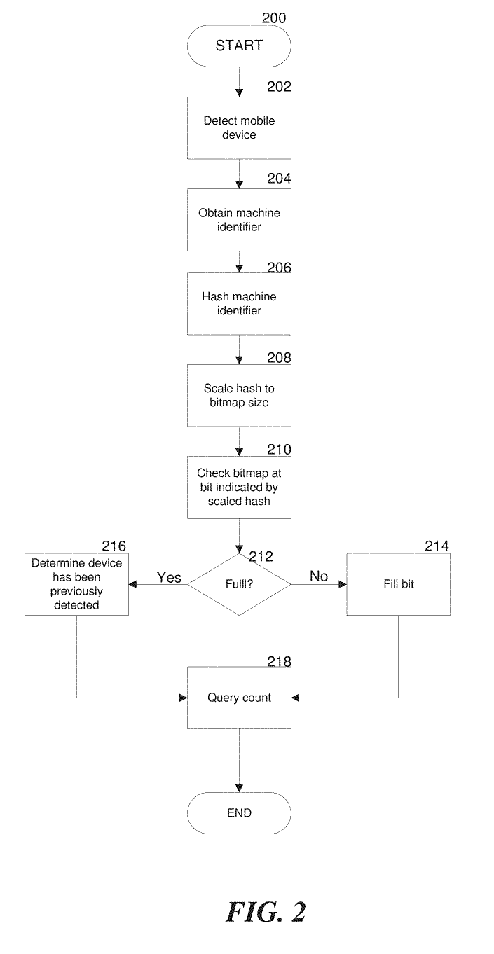

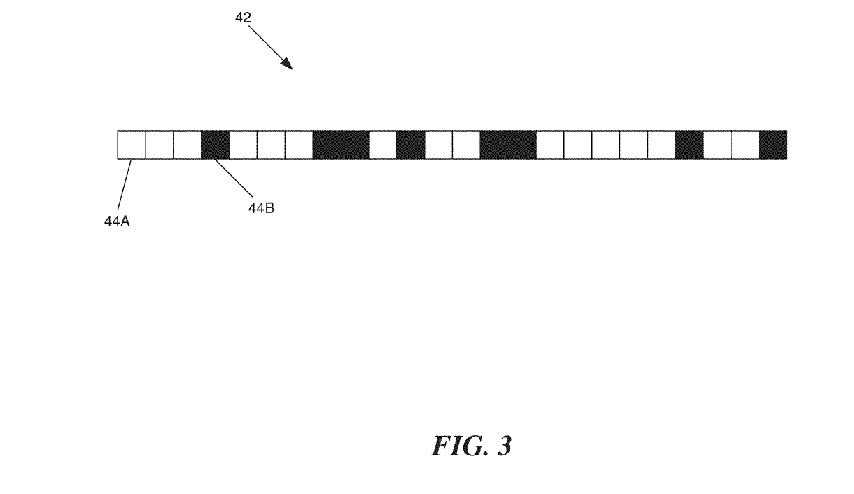

FIG. 3 is an illustration of a bitmap 42 for storing mobile device identifiers. The bitmap is a binary data structure. In some embodiments, a single row bitmap 42 is used to store detection of particular devices. Devices are identified by a location designated by a one-way hash function (and in some embodiments, a scaling function) in the bitmap 42. In other embodiments, different configurations of bitmaps 42 (such as having multiple rows and columns) are usable as long as each has distinct locations, or bits. The figure includes both empty bits 44A and full bits 44B.

An empty bit 44A indicates that the corresponding device has not been detected since the last time the bitmap 42 was cleared. A full bit 44B indicates the corresponding device was detected since the previous bitmap clear. The size of the bitmap 42 varies based on the length of time the bitmap 42 is intended to operate for. As the intended operation time grows, so must the size of the bitmap 42. The bitmap 42 may be referenced for queries concerning particular bits, the number of full bits at any given time, and copy and clear functions. The bitmap 42 of FIG. 3 displays eight detected devices as represented by eight full bits 44B.

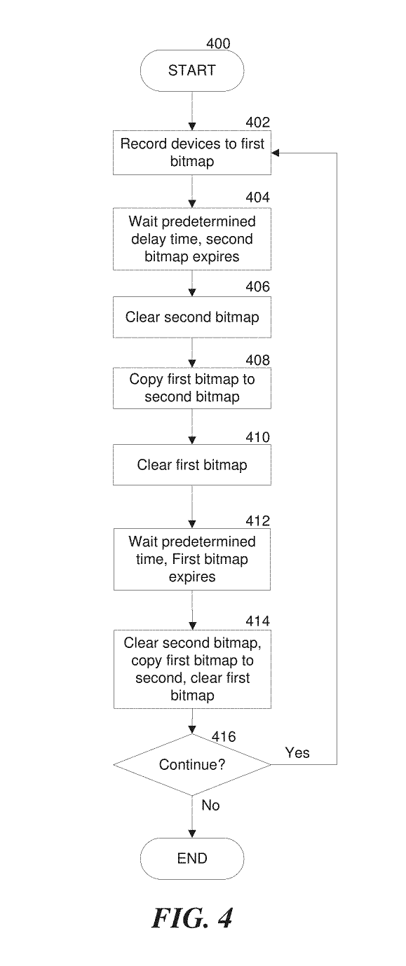

FIG. 4 is a flowchart illustrating a method of rolling bitmaps for consistent coverage. If a given bitmap runs for long enough, every bit will be full, or the number of collisions will no longer be within an acceptable margin of error. Thus, the bitmap needs to be cleared every so often. However, clearing all data ruins the count as the bitmap is cleared. In order to resolve this issue, two or more bitmaps are used in a rolling fashion in order to determine the count.

In step 402, a first bitmap is operated and filled as described in FIG. 2. Devices are detected, their machine identifiers are hashed and scaled to a bitmap, and then bits are filled as devices are detected. The bitmap may be queried for the count.

In step 404, the detection system waits a predetermined delay time from the initializing of the first bitmap in order to begin a second bitmap. The second bitmap matches the first bitmap in size, thus any bits full on the first bitmap correspond to the same device on the second bitmap (within the margin of error). In step 406, the second bitmap is cleared of bits (if any). In step 408, the full bits of the first bitmap are copied to the second bitmap (via union function). In step 410, the first bitmap is cleared. While the first bitmap is cleared, detected devices are continuously recorded to the first bitmap.

In step 412, the detection system waits a predetermined delay time until the first bitmap expires. In step 414, the second bitmap is cleared again, the first bitmap is copied into the second bitmap, and then the first bitmap is cleared (repeat steps 406-410). When a device is detected, the corresponding bit is filled (or recognized as full) in the first bitmap.

If the detection system continues to operate, then the method restarts from step 402. In this manner, two bitmaps run simultaneously, though are staggered. In this manner, the count is never drops to zero suddenly (unless the count is actually zero) as one bitmap is cleared. The current data is queried from both of the bitmaps and added together.

In some embodiments, this method operates with additional bitmaps. Additional bitmaps (beyond two) enables the detection system to provide counts over a greater granularity of time. For three bitmaps, each might have a lifetime of 3.33 minutes. Thus, a given device would remain in the system for a minimum of 6.67 mins and maximum 10 min. The average time of accounting for a phone is 8.34 minutes (6.67+3.33/2). Therefore, the discrepancy is 1.67 minutes.

In this manner, the detection system can guarantee that a given user's information (or a hashed and scaled version of the information) is stored greater than the total lifespan of two bitmaps. Where there are only two bitmaps, the given user's information is stored for a maximum of one lifetime plus the interval between the two bitmaps. For example, if two bitmaps operate with a lifespan of 5 minutes, then the average length of time a user's information may be stored without their continued presence is 7.5 minutes. For three bitmaps the system is able to tell if a phone was seen within 0-3.3 min, 3.3-6.6 min or 6.7-10 min as opposed to just 0-5 and 5-10 min.

Other combinations of shared writes and clears of the rolling bitmaps are also suitable. For example, a clear of both bitmaps is not necessary after the expiration of each of the bitmaps. For example, the method functions if only the first bitmap is cleared when the first bitmap expires, and only the second bitmap is cleared when the second bitmap expires (e.g., skip step 410, and the first portion of step 414 that is corresponds to step 406).

In some alternate embodiments, the process may additionally work where the two bitmaps alternate as the bitmap recording detected devices. The first bitmap records devices for half of its respective lifespan. Halfway through the lifespan of the first bitmap, the second bitmap becomes the recording bitmap. Counting is performed by comparing the full bits of both bitmaps. When any given bitmap expires, it is zeroed out and then takes over as the recording bitmap.

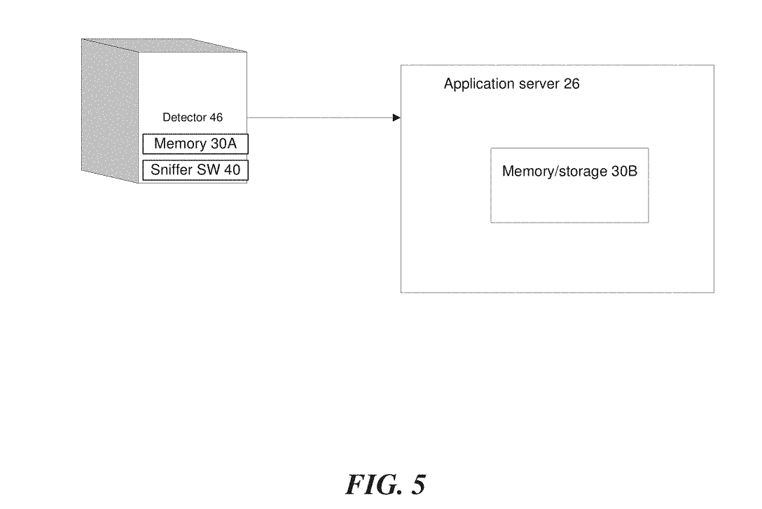

FIG. 5 is a block diagram illustrating data management between a detector and an application server. Many people do not like having their personal identifying information (PII) stored with or without their knowledge. Thus, it is useful to build a system where a given device's machine identifier is never actually stored or recorded for any period.

In some embodiments, a device's machine identifier is never recorded or transmitted. When detected by an on-site detector device (“detector”) 46, the detector 46 immediately hashes the machine identifier. In various embodiments, the bitmaps 40 are ultimately stored on the detectors 46 in a local memory 30A, or on the application server 26 in the server memory 30B. As a result, that the bitmaps require such little storage space, they may be stored in the fastest forms of cache memory (thereby increasing the processing time). In some embodiments, storing the bitmap data in a hard disk or other long-term memory device is unnecessary and even inefficient.

Where the bitmaps are stored on the application server 26, the detectors 46 transmit the hashed identifiers to the application server 26. In these embodiments, the detector software may be very lightweight. The detector 46 only is required to include the detector software, the hashing algorithm, and network communication software. The counting and analytics may be executed on either the detector 46 or the application server 26. Where the counting is executed on the detector 46, the detector's output is merely the count of devices.

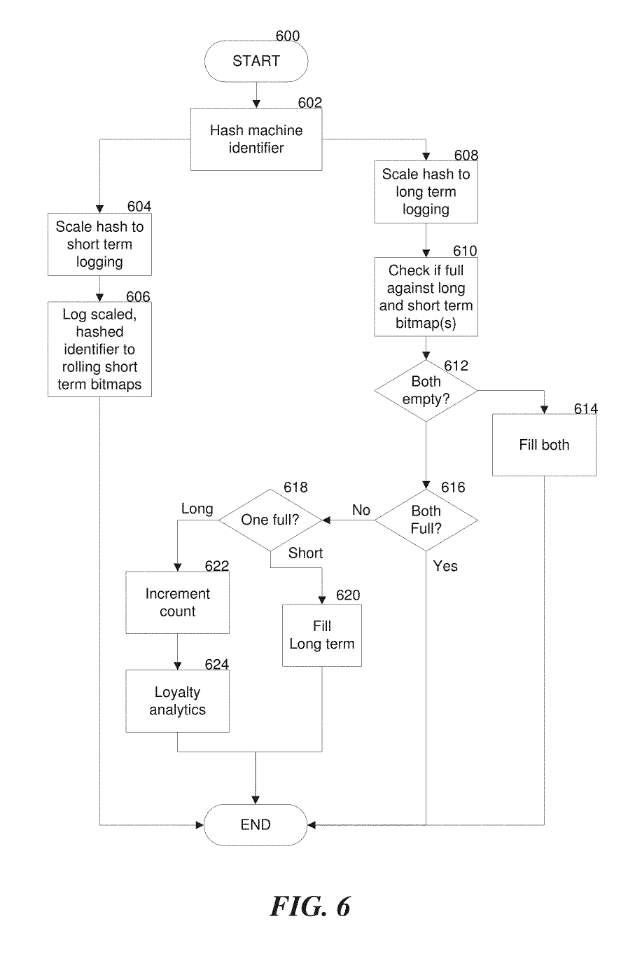

FIG. 6 is a flowchart illustrating a method of maintaining multiple bitmap tracking systems over varied lifespans. Thus far, bitmaps have been disclosed as each having the same lifespan. In some embodiments, bitmaps may have differing lifespans. Having varied lifespans adds additional functionality.

In step 602, the machine identifier of a device is hashed. The same hash function is used regardless of bitmap size or lifespan. In step 604, the hash is scaled to a short-term log (set of rolling bitmaps). In step 606, a first set of rolling bitmaps operates as described in FIG. 4. The count is maintained over a lifespan of, for example, 10 minutes.

In step 608, a second, the scaling function scales the hash to a longer-term log (bitmap or set of bitmaps). The longer-term bitmap(s) may have a lifespan of, for example, a month. Over the course of a given month, it is possible that the short-term bitmap would fill up entirely, or the margin of error would be exceeded. In some embodiments, the size of the bitmap scales to both the number of expected visitors, and the lifespan of the bitmap. Thus, the scaling function is different for the longer-term bitmap(s). However, in order to compare two bitmaps, they must be the same size, and thus use the same scaling function. Thus, in an embodiment where the short term and long-term bitmaps are compared, the scaling function of step 604 and 608 are the same.

In step 610, the scaled and hashed machine identifier is checked against both the long-term and short-term bitmaps. In step 612, the detection system determines whether the bit corresponding to that device is empty in both sets of bitmaps. If not, in step 616, the detection system determines whether the bit corresponding to that device is full in both sets of bitmaps. Where the bit is full in both sets of bitmaps, no further action is taken. If both are not full, in step 618, the detection system determines which of the two bitmap sets is full. If the bit is full in only the short-term bitmap, in step 620 the corresponding bit is filled in the long-term bitmap set.

If the bit is full in only the long-term bitmap, in step 622, a visit counter is incremented. The visit counter is another data structure separate from, but corresponding to the bitmap. On a longer-term bitmap it is possible that a given visitor arrives, leaves, and then returns. In this manner, maintained presence in the location does not increment the counter at each detection (depending on detection rate of the detector, possibly multiple times a second). Rather, the counter is incremented when the short lifespan bitmap does not have record of the particular device. Thus, the device has at least been absent from the location for the short lifespan.

In step 624, analytics may be run on the visit counters. The detection system is enabled to determine the average number of times a given user visits during the long-term bitmap's lifespan. This lets a given location determine whether the traffic experienced is largely repeat or new visitors.

In some embodiments, there are two long-term bitmaps. The two long-term bitmaps operate in a rolling manner similarly to how multiple shorter-term bitmaps operate (e.g., as described in FIG. 4) though with longer periods between bitmap clears.

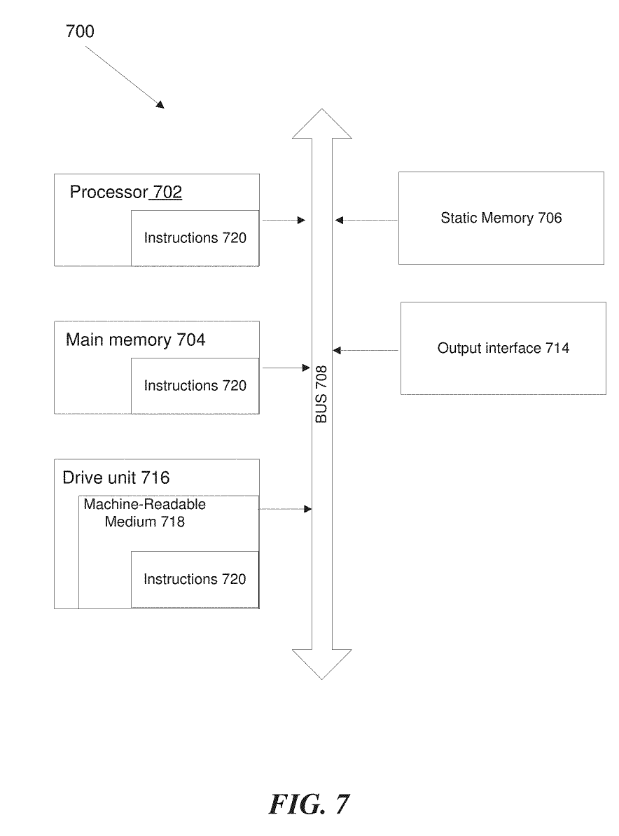

FIG. 7 is a block schematic diagram of a system in the exemplary form of a computer system 700 within which a set of instructions for causing the system to perform any one of the foregoing methodologies and logical flows may be executed.

The computer system 700 includes a processor 702, a main memory 704, and a static memory 706, which communicate with each other via a bus 708. The computer system 700 also includes an output interface 714; for example, a USB interface, a network interface, or electrical signal connections and/or contacts;

The disk drive unit 716 includes a machine-readable medium 718 upon which is stored a set of executable instructions, i.e., software 720, embodying any one, or all, of the methodologies described herein. The software 720 is also shown to reside, completely or at least partially, within the main memory 704 and/or within the processor 702. The software 720 may further be transmitted or received over a network by means of a network interface device 714.

In contrast to the system 700 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g., a computer. For example, a machine-readable medium includes read-only memory (ROM); random access memory (RAM); magnetic disk storage media; optical storage media; flash memory devices; electrical, optical, acoustical or other form of propagated signals such as carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations (e.g., requiring cables and complex software configurations, or requiring a consultant to install). For example, embodiments may provide one or more cloud computing solutions that enable users, e.g., users on the go, to access real-time video delivery on such internet-enabled or other network-enabled devices, servers, or clients in accordance with embodiments herein. It further should be appreciated that one or more cloud computing embodiments include real-time video delivery using mobile devices, tablets, and the like, as such devices are becoming standard consumer devices.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

1. A method to reduce storage requirements for data identifying a mobile device comprising:
receiving a machine identifier corresponding to a mobile device from a mobile device detection system;
evaluating whether a bit in a bitmap corresponding to the machine identifier is full; and
where the bit is not full, filling the bit, and counting an additional mobile device as detected.

2. The method of claim 1 further comprising:
clearing the bitmap of full bits periodically.

3. The method of claim 2, wherein the bitmap is a first bitmap, and the method further comprising:
copying full bits of the first bitmap into a second bitmap wherein the second bitmap has identical size parameters as the first bitmap; and
clearing the second bitmap of full bits periodically.

4. The method of claim 3, further comprising:
querying the mobile device detection system for a count of present mobile devices based on the full bits in the first and second bitmaps combined.

5. The method of claim 3, wherein periodic clearing the second bitmap occurs staggered from the clearing of the first bitmap.

6. The method of claim 5, wherein corresponding bits of the first bitmap are filled in as new mobile devices are detected and the previously recited steps of the method are performed periodically in the recited order below:
periodic clearing of full bits from the second bitmap;
copying full bits of the first bitmap into the second bitmap wherein the second bitmap has identical size parameters as the first bitmap; and
periodic clearing of full bits from the first bitmap.

7. The method of claim 1, further comprising:
generating a hashed machine identifier based on the machine identifier via a hash function, wherein the bit corresponding to the machine identifier is identified based on the hash function.

8. The method of claim 1, further comprising:
querying the mobile device detection system for a count of present mobile devices based on the number of full bits in the bitmap.

9. A method to efficiently store data identifying a mobile device comprising:
receiving a machine identifier corresponding to a mobile device from a mobile device detection system;
scaling the machine identifier to a corresponding first bit and a corresponding second bit respectively from a first bitmap and a second bitmap, wherein the first bitmap has a smaller size parameter than the second bitmap;
clearing full bits from the first bitmap periodically; and
evaluating whether the first bit in the first bitmap and the second bit in the second bitmap are full.

10. The method of claim 9, where the first bit is empty and the second bit is full, the method further comprising:
filling the first bit; and
counting the mobile device as a recurring visitor.

11. The method of claim 9, where the first bit is empty and the second bit is empty, the method further comprising:
filling the first bit and the second bit; and
counting the mobile device as a new visitor.

12. The method of claim 9, further comprising:
clearing the second bitmap of full bits periodically and at a different time than the first bitmap is cleared.

13. The method of claim 9, further comprising:
clearing the second bitmap of full bits periodically;
copying full bits of the second bitmap into a third bitmap wherein the third bitmap has identical size parameters and corresponding bits as the second-d bitmap; and
clearing the second bitmap of full bits periodically, wherein periodic clearing the third bitmap occurs staggered from the clearing of the second bitmap.

14. A system to efficiently store data identifying a mobile device comprising:
a mobile device detector configured to receive a machine identifier corresponding to a mobile device;
a memory in communication with the mobile device detector and storing a first bitmap; and
a processor configured to evaluate whether a first bit of the first bitmap and corresponding to the machine identifier is full in response receiving the machine identifier, the processor further configured to fill the first bit in response to an evaluation that the first bit is not full.

15. The system of claim 14 wherein the memory is further configured to clear the bitmap of full bits periodically.

16. The system of claim 15, wherein the processor is further configured to copy full bits of the first bitmap into a second bitmap stored in the memory wherein the second bitmap has identical size parameters as the first bitmap, the memory is further configured to clear the second bitmap of full bits periodically.

17. The system of claim 16, further comprising:
a user interface configured to receive queries of the mobile device detection system for a count of present mobile devices based on the full bits in the first and second bitmaps combined.

18. The system of claim 16, wherein periodic clearing the second bitmap occurs staggered from the clearing of the first bitmap.

19. The system of claim 18, wherein the processor is configured to fill in corresponding bits of the first bitmap as new mobile devices are detected and processor is further configured to perform the following actions periodically in the recited order below:
periodic clearing of full bits from the second bitmap;
copying full bits of the first bitmap into the second bitmap wherein the second bitmap has identical size parameters as the first bitmap; and
periodic clearing of full bits from the first bitmap.

20. The system of claim 14, wherein the processor further includes instructions that when executed generate a hashed machine identifier based on the machine identifier via a hash function, wherein the bit corresponding to the machine identifier is identified based on the hash function.

21. The system of claim 14, further comprising:
a user interface configured to receive query the mobile device detection system for a count of present mobile devices based on the number of full bits in the bitmap.
